(19) United States
(12) Patent Application Publication
(10) Pub. No.: US 2005/0254880 A1
(43) Pub. Date: Nov. 17, 2005

(54) Colorant devices and methods

(76) Inventors: Lisa A. Brajdic, DePere, WI (US); Ty A. Dorn, DePere, WI (US)

Correspondence Address: WILHELM LAW SERVICE, S.C., 100 W LAWRENCE ST, THIRD FLOOR, APPLETON, WI, 54911, US

(21) Appl. No.: 10/843,120

(22) Filed: May 11, 2004

(51) Int. Cl. A45D 33/00; A46B 11/00; B43K 27/04

(52) U.S. Cl. 401/130; 401/126; 401/35; 401/17

(57) ABSTRACT

Colorant systems of the invention comprise colorant devices, and methods of use, such colorant device having a plurality of receptacle structures therein, and at least one, optionally multiple, colorant applicators, which are adapted and configured to be removably mounted, optionally slidingly mounted, in such receptacle structures, and are adapted and configured to apply a colorant composition to such colorant receptive surface. Such colorant applicator can comprise a painting element adapted and configured to receive colorant from a cooperatively configured multiple-cell tray, and to transfer the colorant onto a colorant receptive surface.

### BACKGROUND

The present invention relates to apparatus for applying paint and/or other colorant to any paintable and/or otherwise colorable surface, and methods of using such apparatus. In particular, the present invention relates to colorant devices for applying decorative effects to, e.g. a wall.

Decorative effects are applied to surfaces using a variety of techniques. Techniques for applying decorative effects to surfaces include glazing, plastering, aging, stenciling, marbleizing, wood graining, stamping, spattering, clouding, and others.

Decorative effects are conventionally applied to surfaces to modify the looks of such surface, often to make such surface more aesthetically pleasing to some individuals. Some decorative effects, broadly categorized as faux finishes, are applied to surfaces to, e.g. make such surfaces appear like other surfaces.

For example, interior walls can be faux finished to resemble marble, granite, clouds, wood grains, stucco, suede, as well as other surfaces, structures, and/or images. It is advantageous to use decorative effects to mimic such surfaces, structures, and/or images because using the actual surfaces, structures, and/or images often proves prohibitively costly or otherwise not feasible.

Faux finishes and other decorative painting effects can be applied to surfaces, such as interior walls, by utilizing a variety of specialized tools, devices, and methods of application. Such specialized tools, devices, and methods of application include, but are not limited to, painting with sponges, rolling rags and/or other articles across wet paint, dragging paint brushes across wet paint, applying paint through openings which extend through a stencil, and others.

Many of these known methods of applying decorative painting effects require that a handle-less tool/device be held in the hand of the individual applying such method, one example being when the tool/device is e.g. a sponge or rag. The individual applying such decorative painting effect with a handle-less tool/device is susceptible to getting the colorant on his/her hand.

In addition to numerous tools and devices, some methods of applying decorative painting effects require a great deal of skill, coordination, and artistic ability. Often decorative painting effects, such as faux finishes, require multi-step application processes, as well as paints, solvents, glazes, and/or other colorants. Some multi-step applications require the use of numerous tools/devices during each application step, and/or between application steps.

It would thus be advantageous to provide improved devices and methods for applying decorative effects to surfaces. It would be especially advantageous to provide devices which are more versatile, e.g. a device which enables a user to replace/interchange the paint/colorant applying part of the device, and thus enabling the user to adapt such device to apply a relatively greater variety of decorative effects than conventional devices.

It is thus desirable to provide a colorant device which has a plurality of receptacle structures, each of which can accept at least one colorant applicator therein.

It is also desirable to provide a colorant device which has a plurality receptacle structures, each of which can accept at least one colorant applicator therein, thereby enabling a user to select a colorant applicator which corresponds to a desired painting effect.

It is yet further desirable to provide a painting system which enables a user to transfer a plurality of paints and/or other colorants onto a paintable and/or otherwise colorable surface, substantially simultaneously.

It is still further desirable to provide a method of decorating a surface, which is susceptible to receiving colorant thereon, by applying, substantially simultaneously, a plurality of different colorants to such surface, thereby to provide a multiple-color surface affect.

### SUMMARY

Colorant systems of the invention comprise a colorant device having a plurality of cavities therein. Each of the cavities of the colorant device is adapted and configured to receive a colorant applicator therein. The colorant applicator can comprise a painting element adapted and configured to receive paint and/or other colorant from e.g. a cooperatively configured tray, and to transfer the paint and/or other colorant onto a paintable and/or otherwise colorant receptive surface.

In a first family of embodiments, the invention comprehends a colorant device, adapted and configured to apply colorant compositions to a colorant receptive surface. The colorant device comprises a body having a top and a bottom, and at least first and second receptacle structures associated with the bottom of the body; and at least one colorant applicator adapted and configured to apply a colorant composition to such colorant receptive surface, the colorant applicator and at least one of the receptacle structures being cooperatively adapted and configured such that the at least one colorant applicator can be removably mounted in one of the receptacle structures.

In some embodiments, the receptacle structures can comprise sliding mounting structures adapted and configured to mount a cooperatively configured colorant applicator in the respective receptacle structure.

In some embodiments, at least first and second ones of the colorant applicators are mounted in at least first and second ones of the receptacle structures.

In some embodiments, the body comprises a first receptacle structure between the top of the body and at least a portion of a second receptacle structure.

In some embodiments, the body has a length and a width, and the body comprises a receptacle structure element between extremities of the width.

In some embodiments, the receptacle structure element assists in stabilizing a colorant applicator mounted in a receptacle structure, at other than an edge of the respective colorant applicator.

In some embodiments, each of the at least first and second colorant applicators has a colorant-applying bottom, adapted and configured to apply a colorant expression to such colorant receptive surface, the colorant expression, independent of color of colorant material being applied, of the first colorant applicator being different from the colorant expression of the second colorant applicator.

In some embodiments, the colorant device comprises at least first, second, and third colorant applicators mounted in the body. Each of the at least first, second, and third colorant applicators has a colorant-applying bottom, adapted and configured to apply a colorant expression to such colorant receptive surface, the colorant expression of the first colorant applicator being different from the colorant expression of either of the second and third colorant applicators.

In a second family of embodiments, the invention comprehends a colorant kit adapted and configured to apply colorant compositions to a colorant receptive surface. The colorant kit comprises a colorant device comprising a body having a top and a bottom, and at least first and second receptacle structures associated with the bottom of the body, and at least first and second colorant applicators adapted and configured to apply colorant composition to a colorant receptive surface, the colorant applicators being removably mountable in the at least first and second receptacle structures. The kit further comprises a tray, having a plurality of cells, at least as great in number as the number of colorant applicators which can be removably mounted in the body, the cells being separated from each other by liquid-tight separators which effectively isolate any colorant composition, in the cells, from each other. The colorant applicators, mounted on the colorant device, and the cells in the tray, are cooperatively arrayed with respect to each other such that the colorant device can be manipulated to bring the colorant applicators into generally concurrent communication with respective ones of the cells such that the colorant applicators communicate with respective different colorant materials in different ones of the cells, such that different ones of the colorant applicators pick up different colorant materials from the cells, which colorant materials can be concurrently applied, by the colorant device, to the respective colorant receptive surface.

In a third family of embodiments, the invention further comprehends a colorant kit adapted and configured to apply colorant compositions to colorant receptive surfaces. The colorant kit comprises a colorant device comprising a body having a top and a bottom, and at least first and second receptacle structures associated with the bottom of the body, wherein the first and second receptacle structures are adapted and configured to receive respective at least first and second colorant applicators therein in a first predetermined pattern. The kit further comprises a tray, comprising a bottom, an outer perimeter wall, and at least one separator, dividing the tray into a plurality of cells, each cell being adapted and configured to receive and hold liquid colorant therein without the liquid colorant flowing to an adjacent cell. The cells in the tray are arranged and configured in a second pre-determined pattern which is consistent with the tray concurrently receiving working surfaces of the at least first and second colorant applicators in the respective cells such that each such colorant applicator is received in a separate such cell, whereby colorant in ones of the cells can be transferred onto respective ones of the colorant applicators.

The invention further comprehends a method of applying colorant to a colorant receptive surface. The method comprises depositing colorant into a tray having a plurality of separate and distinct cells which are adapted and configured to maintain separation between colorants in the respective cells; installing a first set, comprising at least first and second colorant applicators, in a body of a colorant device which is adapted and configured to receive multiple such colorant applicators in an array of such applicators; transferring at least some of such colorant from the plurality of cells onto corresponding ones of the at least first and second colorant applicators in the first set, and transferring at least some of such colorant from the at least first and second colorant applicators onto such colorant receptive surface.

The method can further comprise removing the first set of colorant applicators from the body of the colorant device, and installing a second set of colorant applicators, the first set of colorant applicators being adapted and configured to collectively define a first visual pattern of colorant expression on the colorant receptive surface, the second set of colorant applicators being adapted and configured to collectively define a second visual pattern of colorant expression on the colorant receptive surface, the second visual pattern being different from the first visual pattern, independent of color. The method can further comprise transferring colorant from the plurality of cells of the tray onto corresponding ones of the second set of colorant applicators; and transferring at least some of the colorant from the second set of colorant applicators onto the colorant receptive surface, or onto a second, distinct, colorant receptive surface.

### BRIEF DESCRIPTION OF THE DRAWINGS

FIG. 1 shows a perspective view of a first embodiment of colorant devices of the invention.

FIG. 2 shows an exploded perspective view of parts of the colorant device of FIG. 1, with a colorant applicator displaced from the body of the colorant device.

FIG. 3 shows a perspective view of a second embodiment of colorant devices of the invention, with a colorant applicator joined to the body of the colorant device.

FIGS. 4-6 show front elevation views of the body of the colorant device of FIG. 1.

FIG. 7 shows a front elevation view of a removable colorant applicator of the colorant device of FIG. 1.

FIGS. 8 and 9 show perspective views of the colorant-applying surface of the painting element of the colorant applicator.

The invention is not limited in its application to the details of construction or the arrangement of the components set forth in the following description or illustrated in the drawings. The invention is capable of other embodiments or of being practiced or carried out in other various ways.

Also, it is to be understood that the terminology and phraseology employed herein is for purpose of description and illustration and should not be regarded as limiting. Like reference numerals are used to indicate like components.

### DESCRIPTION OF THE ILLUSTRATED EMBODIMENTS

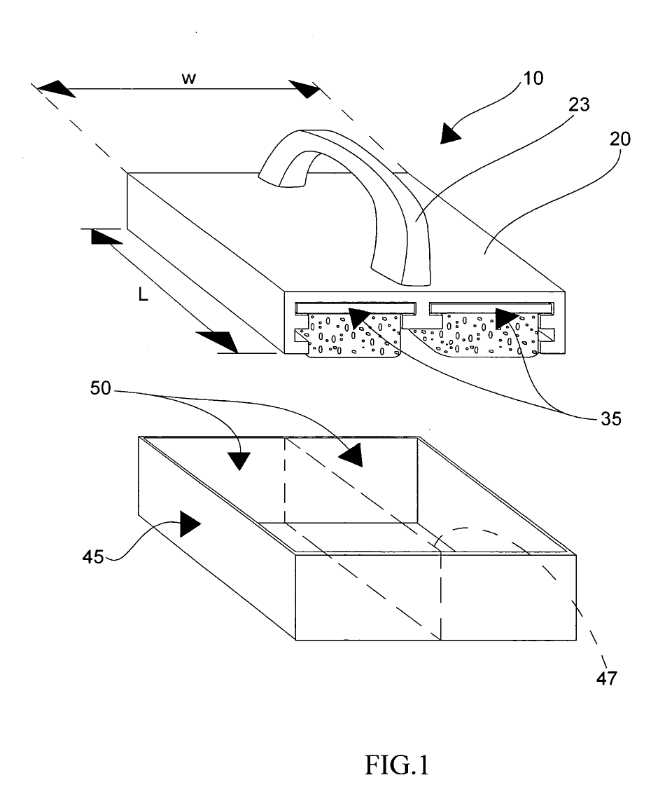

FIG. 1 illustrates a first embodiment of painting systems 1 of the invention. Painting systems 1 of the invention can be used to apply paint and/or other colorant to a surface which is capable of receiving paint or other colorant coating.

A painting system 1 of the invention includes a plurality of cooperating components including, but not limited to, colorant device 10, and tray 45 which receives colorant which is to be applied by colorant device 10.

Colorant device 10 includes a body 15, and one or more colorant applicators 16 which are removably received in body 15. Body 15 includes lateral edges 17, 18, and a top panel 19, which has a top surface 20 and a bottom surface 25. Receiving structures 30, 31, and 32 extend downwardly from top panel 19. Each applicator 16 includes a base panel 35, and a painting element 37 mounted to the base panel.

Tray 45 typically includes a partition 47 and, correspondingly, cells 50A and 50B which receive, hold, and dispense colorant material to the painting elements 37. Where partition 47 is not used, all painting elements apply a common colorant, but can apply different design patterns if and as desired, according to the images expressed at the bottoms of the respective painting elements.

As illustrated, lateral edges 17 and 18, of body 15, extend generally parallel to each other, and define width dimension “W” of the body therebetween. Body 15 further defines a length dimension “L” which extends in a direction generally perpendicular to the width dimension, and corresponds to the overall length of body 15. Lateral edges 17 and 18, and indeed the front and back edges, of the body, can be other than straight, as well as generally non-parallel to each other, by design choice without departing from the scope of the invention, whereupon the length “L” and width “W” are defined by extremities of the edges from longitudinal and transverse centerlines of body 15.

Handle 23 extends upwardly from top surface 20. Handle 23 is illustrated as being generally arcuate, and extends between first and second points of terminus, the points of terminus communicating with top surface 20. Those skilled in the art appreciate that the design and configuration of handle 23 can vary extensively, and thus any structure which enables a user to grip, hold, and/or manipulate colorant device 10 is within the scope of the current invention. In general, handle 23 is typically sized, shaped, and/or otherwise adapted and configured to correspond to the size and shape of the hand of a typical user, thereby enabling comfortable, alternatively ergonomic, use of colorant device 10.

Bottom surface 25, of top panel 19, has a width dimension which corresponds generally to width dimension “W”, less corresponding thicknesses of receiving structures 30, 31, and a length dimension which corresponds generally to length dimension “L”. In the illustrated embodiments, bottom surface 25 defines a plane which extends generally parallel to a plane defined by, or which generally contains, top surface 20. However, top 20 and bottom 25 surfaces need not be parallel, or planar.

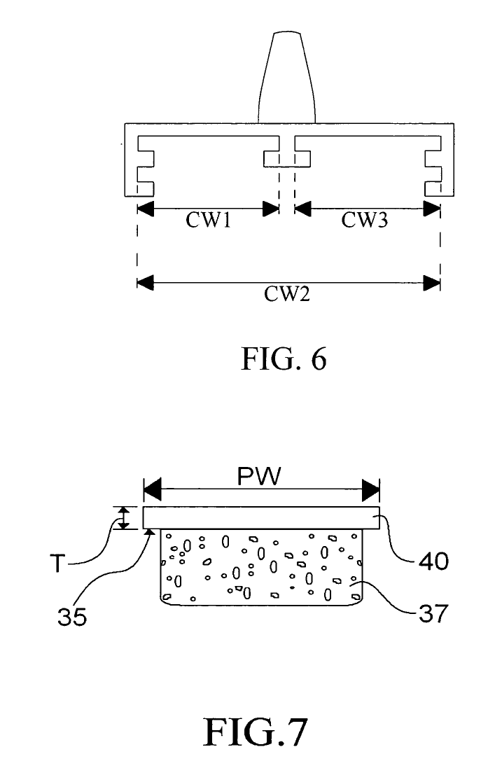

Each receiving structure 30, 31, 32 defines at least one laterally opening channel. As illustrated in FIG. 6, receiving structure 30 defines upper and lower laterally opening channels 30CU and 30CL. Similarly, receiving structure 31 defines upper and lower laterally opening channels 31CU and 31CL. Finally, receiving structure 32 defines left and right laterally-opening, and laterally opposed, channels 32CL and 32CR. As illustrated in FIG. 4, the distances between the tops and bottoms of channels 30CU, 31CU, and 32CL, 32CR define channel minimum open height dimensions “H1” which are at least as great as thickness dimensions of slidable elements 40 of top panels 19 which are adapted and configured to be received in the respective channels. Similarly, the vertical perpendicular distance between the distal bottom end 36 of receiving structure 32, and the bottoms of channels 30CL and 31CL defines a channel minimum open height dimension “H2” which is at least as great as a thickness dimension of a slidable element 40 of a top panel 19 which is adapted and configured to be received into the respective channels 30CL and 31CL.

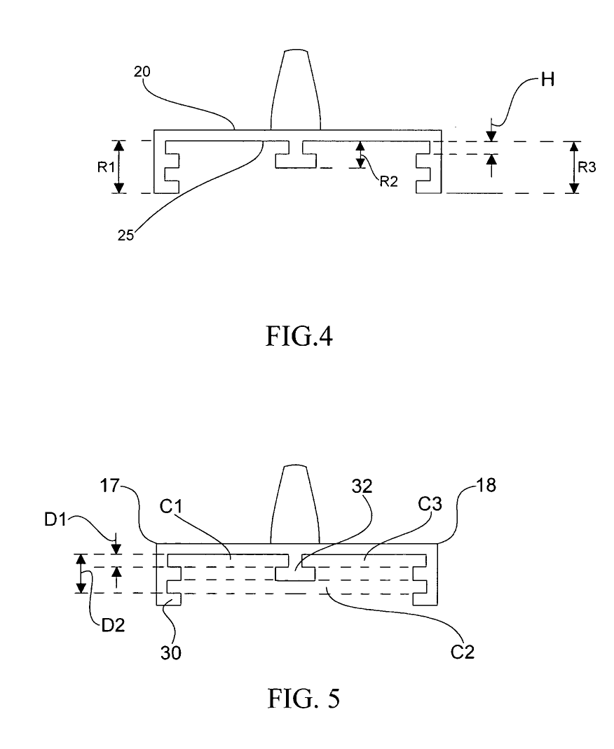

As illustrated, colorant device 10 has first, second, and third receiving structures 30, 31, 32. Referring to FIGS. 4 and 5, first receiving structure 30 extends downwardly from top panel 19 generally adjacent lateral edge 17. Second receiving structure 31 extends downwardly from top panel 19 generally adjacent lateral edge 18. Third receiving structure 32 extends downwardly from top panel 19 generally mid-way between first receiving structure 30 and second receiving structure 32.

Receiving structures 30, 31, 32, in combination with their respective channels, generally define receptacle structures which receive colorant panels 35. Referring to FIG. 5, receiving structures 30 and 32, in combination with channels 30CU and 32CL, define first receptacle structure C1. Receiving structures 30 and 31, in combination with channels 30CL and 31CL, define second receptacle structure C2. Similarly, receiving structures 31 and 32, in combination with channels 31CU and 32CR, define third receptacle structure C3.

Referring to FIGS. 5 and 6, each of receptacle structures C1, C2, C3 has a width dimension which corresponds to the distance between the respective channels. First receptacle structure C1 thus has a corresponding width dimension CW1. Second receptacle structure C2 thus has a corresponding width dimension CW2. Third receptacle structure C3 has a corresponding width dimension CW3.

Referring to FIG. 5, receptacle structures C1 and C3 extend downwardly from bottom 25 a first distance D1. Second receptacle structure C2 extends downwardly from the bottom 36 of receiving structure 32 a second distance D2, which in this embodiment, corresponds to the distance between the upper and lower surfaces of the respective channels 30CL and 31CL. As desired, receptacle structure C2 can be spaced vertically from receiving structure 32 whereby an unoccupied space exists between the bottom of receiving structure 32 and the upper portion of the position occupied by receptacle structure C2.

Base panel 35 is generally planar, having panel width dimension “PW”, panel length dimension “PL”, and panel thickness dimension “T”.

Painting element 37, and especially the bottom 42 of the painting element, can comprise a wide variety of textures within the scope of the invention. In some embodiments, painting element 37 has a generally planar bottom 42, alternatively a generally and/or substantially irregular bottom.

Painting element 37 can have a bottom which has a pattern and/or texture which expresses, on the paint-receptive surface, a commonly-known pattern or texture or image. In the alternative, painting element 37 can have a bottom which has a relatively random pattern and/or texture, and/or a pattern or texture which is not commonly known.

Alternatively, or in combination with such variety of texture and/or pattern, painting element 37 can comprise any of a wide variety of protrusions extending downwardly from, and/or any of a wide variety of recesses extending inwardly into, the main body of painting element 37, thus to define any of a wide variety of profiles and/or reliefs at the bottom of element 37, while remaining within the scope of the invention.

The bottom features of painting element 37 can represent a regularly repeating pattern in the bottom surface, a single pattern element in the bottom surface, or a more random pattern which may, as to the painting element, have no substantial repeating visual features, alternatively which expresses no substantial repeating visual features on a surface which is colored, painted, using the painting element.

FIG. 8 illustrates a colorant device 10 supporting four painting elements 37 mounted therein, wherein each of the painting elements represents application of a different, but commonly-recognizable image to the colorant-receptive surface.

FIG. 9 illustrates a colorant device 10 supporting four painting elements 37 mounted therein, wherein two of the painting elements represent patterns which repeat within the respective painting element, and wherein two of the painting elements represent random patterns which have no repeating pattern in and of themselves.

By making multiple applications of paint to a surface, using a given set of applicators 16 in the colorant device, the resulting appearance on the surface typically has an inherent repeat pattern characteristic, which results from the repeat applications. In instances where the image being applied by the respective painting elements is not 360 degrees symmetric, or where different images are used in the respective receptacle structures, such repeat pattern, resulting from repeated applications of the same set of applicators, at spaced or adjacent or overlapping locations on the colorant receptive surface, can be modified so as to be less recognizable as a repeat pattern by e.g. rotating the colorant device between subsequent applications of the painting elements to the respective colorant receptive surface. Such repeat pattern potential can also be modified by alternating use, on a given colorant-receiving surface, of multiple ones of the colorant devices, at least two of which, preferably all of which, bear a different-design set of painting elements 37.

Painting element 37, as to its working lower surface, extends downwardly from top panel 19 sufficiently far so as to extend downwardly beyond receiving structures 30, 31 and thus beyond the lowermost portion of body 15 to its bottom 42 at the lower working surface.

Slidable elements 40 of base panel 35 extend outwardly beyond painting element 37 along at least part, optionally all, of the length dimension “PL” of colorant applicator 16. Base panel 35 and slidable elements 40 are sufficiently strong to bear the load of colorant applicator 16, including painting element 37, and any paint and/or other colorant being carried by the painting element, while the colorant applicator is in use.

Tray 45 has a width which corresponds generally at least to width dimension “W” of colorant device 10, and a length dimension which corresponds generally at least to length dimension “L” of colorant device 10.

Tray 45 has a closed bottom, a plurality of sides extending upwardly from the bottom, and a substantially open top.

The plurality of upstanding walls of tray 45 define at least one cell 50 therebetween, which is adapted and configured to hold paint and/or other colorant. In the illustrated embodiments, tray 45 further comprises partition 47, which is adapted and configured to separate tray 45 into a plurality of cells 50A, 50B et al, which are generally liquid-tight with respect to each other.

With partition 47 in place, ones of cells 50 are generally defined between partition 47 and at least one wall. In the alternative, tray 45 comprises a plurality of partitions 47 whereby tray 45 defines more than two cells 50; the more than two cells 50 preferably corresponding to ones of a plurality of colorant applicators 16 or multiple portions of a single colorant applicator. In general, the partitions provide sufficient barrier to colorant flow to prevent liquid colorant material, in a given cell 50, from flowing to any adjacent cell.

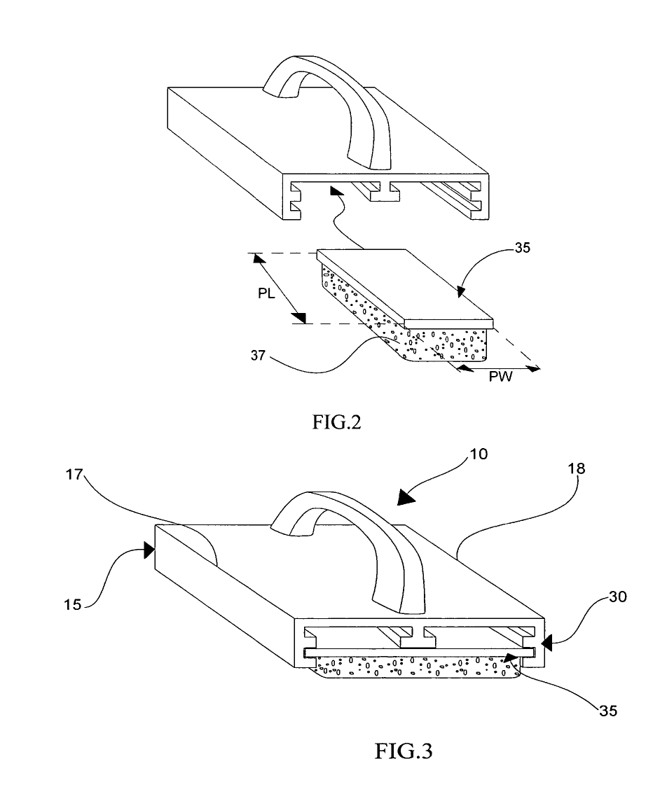

Referring to FIGS. 2 and 3, the overall shape and size, e.g. length and width, of a given colorant applicator 16 corresponds in general to the length and width of the respective receptacle structure C1, C3, C2, whereby the corresponding applicator 16 can be fitted into, and/or attached to, preferably removably attached to, body 15 at the respective channels.

Channel height “H1” or “H2” (FIG. 4) typically has a magnitude greater than the magnitude of the thickness dimension “T” of base panel 35.

Referring to FIGS. 2 and 7, panel width “PW” has a magnitude modestly less than the magnitude of a corresponding width magnitude e.g. CW1 and/or CW3 of the respective receptacle structure, while being sufficiently great to be retained in the respective channels. The relationships between the magnitudes of channel height “H1”, “H2”, panel thickness dimension “T”, panel width “PW”, and receptacle structure widths CW1, CW3, enable base panel 35 to be slidingly received into at least one of receptacle structure C1 and receptacle structure C3.

Referring to FIG. 3, base panel 35 can have dimensions which correspond to the dimensions of second receptacle structure C2, whereby base panel 35 is adapted and configured to be received into second receptacle structure C2.

Base panel 35 can be adapted and configured to be slidingly received into two different sizes of receptacle structures. In such embodiment, one of panel length dimension “PL” and panel width dimension “PW” corresponds to either the width dimension CW1 or width dimension CW2; and the other of panel length dimension “PL” and panel width dimension “PW” corresponds to the other of width dimension CW1 and width dimension CW2.

In the embodiments illustrated, the channels, e.g. 30CU, 32CL represent female receivers while slidable elements 40 represent cooperating male counterparts which are received into the female receivers. Such male, female relationships can be reversed, such that receiving structures 30, 31, 32 include elongate male projections, and slidable elements 40 include female channels. Respective ones of the elongate projections of receiving structure 30, 31, 32 and ones of the channels formed in slidable elements 40 are thus adapted and configured to cooperate with each other, enabling colorant applicators 16, namely base panels 35, to be slidingly received into, and removably held in, body 15.

In some embodiments, painting elements 37 comprise a porous and/or absorbent material which receives the colorant into interstices in the painting element. Such porous and/or absorbent materials include but are not limited to sea sponge, rubber sponge, cellulose sponge, natural wool, synthetic wool, natural cotton, synthetic cotton, natural silk, synthetic silk, natural cellulose, synthetic cellulose, fiberglass, rayon, and/or other porous and/or absorbent materials.

As one non-limiting example, the porous and/or absorbable material can be shaped and configured, at the bottom surface 42 of the painting element, to resemble generally recognizable shapes or images in either positive or negative expression, including but not limited to leaves, stars, flowers, ivy, vines, bricks, animals, and others. The generally recognizable shapes configured into or out of painting elements 37, either as male/positive or female/negative relief, enables a user to apply corresponding generally recognizable shapes to a paintable and/or other colorable surface.

The painting element and/or the paint-applying bottom 42 of the painting element, can be shaped so as to apply an image which has a generally random appearance, or can be shaped so as to apply a shape or image which has repeating, generally non-recognizable shapes or images.

The above discussion addresses the general nature, e.g. either random or repeating nature, of the image which is applied to a colorant-receptive surface, relating that image to the nature of the image which is defined at the bottom 42 of the painting element. Such bottom 42 can transfer either a positive image from a projecting portion of the bottom 42 or a negative image expressed as a void in the bottom of the printing element 37, whereby the image is defined by surrounding color transfer while leaving the underlying colorant-receiving surface uncoated in the area wherein the image is defined, thus a negative image.

The above discussion also addresses the repeating nature of the image which can be applied by controlling the relative locations and orientations of images on the bottoms 42 of the painting elements, which bottoms are sequentially applied to the colorant-receptive surface by one or more colorant devices 10. Such colorant devices can be used on a given colorant-receptive surface to apply different colors, different images, or the like in order to bring a greater degree of diversity to the image than can be applied by using a single colorant device applying a single set of painting elements, and a single set of colorant materials.

As an additional degree of freedom in using the invention, the user can employ, on a given painting project, at a colorant receptive surface, a plurality of colorant devices 10 wherein at least two of the colorant devices have different plan view layouts of the receptacle structures and corresponding painting applicators 16 and/or different colors of colorant, paint, coating materials in the painting elements For example, a first colorant device can have two applicators 16 in side-by side relationship;

while a second colorant device can have 4 applicators 16, arranged in a straight line; of a third colorant device can have 3 applicators arranged to collectively define a triangle.

The number and arrangements of the applicators in body 15, and the corresponding design and configuration of the body to receive and hold the applicators, can thus vary widely according to the demands and desires which are associated, by a user, with the coloring job at hand. One can correspondingly, contemplate a wide variety of overall plan view outlines for the bottom surface of body 15, as well as a wide variety of receptacle structure layouts, and a wide variety of configurations of the respective receptacle structures at the bottom of the body. Corresponding layouts are typically applied to tray 45 so that each applicator 16 picks up colorant from a particular cell 50, and no other applicator picks up colorant from that same cell 50.

Painting elements 37 can comprise relatively non-porous and/or non-absorbent material which can, but do not have to, include either male or female patterns of relief or texture. Relatively non-porous and/or non-absorbent materials include but are not limited to polymeric materials, e.g. the polyolefins, the polyols, the polystyrenes, the polyvinyls, rubbers, elastomers, and/or other relatively non-porous and/or non-absorbent materials, which typically hold paint and/or other colorant by e.g. surface tension.

The bottom 42 of such relatively non-porous and/or non-absorbent material can be arranged in generally repeating configurations. Such configurations include, but are not limited to, painting elements 37 which comprise, e.g. a mass of closely-spaced stippling strands having ends embodied in bottom 42. Alternatively, or in combination with generally repeating configurations, bottom 42 can comprise generally random configurations of colorant-transferring material, e.g. a portion of a bunched, rolled, or crumpled plastic bag.

In some embodiments, ones of painting elements 37 are fabricated substantially integral with respective ones of base panels 35, and can even comprise the same material, whereby base panels 35 can be described as extending below body 15 sufficiently so as to enable effective use of painting system 1.

Bottom 42 of any of the painting elements can include more than one of the above described types of material which receives and transfers the colorant to the colorable surface. For example, bottom 42 of a given painting element 37 can be a combination of absorbent and non-absorbent materials, optionally with or without stippling strands. Further, the bottoms in respective adjacent ones of the painting elements in a given colorant device can comprise any of the known colorant-transferring surface materials, whether absorbent or non-absorbent. Thus, a given colorant device can simultaneously carry a first painting element wherein the bottom is largely absorbent material while the bottom of an adjacent painting element 37 is largely non-absorbent material or stippling strands. Having the option for such variety in adjacent painting elements of a colorant device adds to the versatility of the device in terms of the different visual affects which can be achieved by use of the colorant device.

Any paint and/or other colorant which is conventionally known for use with a conventional paint or colorant applicator, to apply colorant to a receptive surface, is suitable for use with the present invention, provided a correspondingly suitable material is used at bottom 42 for receiving and transferring the colorant material. Such conventionally known colorants include, but are not limited to, latex enamels, alkyd enamels, latex stains, alkyd stains, epoxy enamel coatings, acrylic latex coatings, inks, and/or other colorants. The paint, and/or other colorant can be applied to any paint and/or other colorant receptive surfaces. Such surfaces include but are not limited to interior walls e.g. plaster, drywall, wallpaper; exterior walls e.g. hardboard siding, stucco, cement, vinyl, aluminum; and furniture.

A user of colorant devices of the present invention selects a colorant applicator 16 having a painting element 37 which has a texture, design, and/or configuration corresponding to the desired decorative effect at bottom 42. The user attaches applicator 16 to body 15 by e.g. slidingly inserting slidable elements 40 of panel 35 into corresponding receiving structures 30, 31, 32. The user grasps colorant device 10 by handle 23 and manipulates colorant device 10, dipping painting elements 37 into paint and/or other colorant material which is contained in the respective cells of tray 45.

Where the user inserts a plurality of applicators 16 into body 15, tray 45 comprises a corresponding plurality of cells 50. Each of the plurality of applicators 16 corresponds to one of the plurality of cells 50 in tray 45. The user typically fills each of cells 50 with a desired paint and/or other colorant, typically a different paint or other colorant in each cell, which enables the user to substantially concurrently apply a different paint and/or other colorant to each of the applicators 16, and subsequently to substantially concurrently apply a plurality of paint and/or other colorant materials to a paintable and/or otherwise colorable surface.

The user then takes colorant device 10, preferably by handle 23 and daubs, stamps, drags, brushes, or otherwise interfaces colorant device 10 against the paintable and/or otherwise colorant receptive surface, whereby at least some of the paint and/or other colorant is transferred from painting elements 37 to such colorant receptive surface. The user repeats this step, or refrains from repeating this step, as desired, so as to create the desired effect e.g. decorative painting effect upon the desired fraction of the colorant receptive surface.

When the user has finished with the use of one or more of the respective color applicators 16, the color applicator can be removed from body 15, and the colorant device used further with the respective receptacle empty, or filled with a different colorant applicator, to finish the job. In the alternative, the entirety of a job can be accomplished with a single set of such colorant applicators in the colorant device.

When the user prepares for a subsequent job, or a subsequent application of colorant to the same surface, now having at least a first colorant coating thereon, the user anew selects the desired colorant applicators, which may be the same applicators last used, or may be a partially different set of colorant applicators, or a completely different set of colorant applicators. Such colorant applicators may differ in design of the bottom surface which applies colorant to the receptive surface, may differ in cleanliness, may differ in degree of wear, or other parameter of interest to the user.

Thus, the user can change the colorant applicators at will, e.g. between jobs, or while in the midst of a job. Such change can be for purpose of achieving a different design or pattern, a different color, a more distinct pattern by using a cleaner applicator, or the like. Thus, by designing and configuring the colorant device and tray of the invention as taught herein, the user has a great degree of versatility in the variety and quality of finishes which can be applied to a colorant receptive surface.

The number of discernibly different colors which are applied concurrently to the colorant receptive surface can be any number, up to and including the number of applicators 16 which are mounted in the colorant device 10. Where a smaller number of colors are desired, a common color is loaded into more than one of the cells 50 of the tray.

Just as the number of colors can be any number, up to the number of applicators 16, likewise the number of designs, expressed at bottom surfaces 42, can be any number up to the number of applicators which can be received in body 15, where each applicator is considered to be a single design. Thus, all applicators can express the same design or pattern, e.g. leaves. Or each applicator can express a different design, such as leaves, flowers, trees, or different animals, expressions of man-made products or ideas, in any mix/match combination of applicators.

In preferred embodiments, painting system 1 is made of polymeric material, which resists corrosion, is relatively strong and durable. Those skilled in the art are well aware of materials which posses such desirable qualities, and appropriate methods of forming such materials.

Suitable materials are various polymeric materials, such as for example and without limitation, various of the polyolefins, such as a variety of the polyethylenes, e.g. high density polyethylene, or polypropylene. There can also be mentioned such commodity polymers as polyvinyl chloride and chlorinated polyvinyl chloride copolymers. A wide variety of other materials, can also be used, as desired.

For any polymeric material employed in structures of the invention, any conventional additive package can be included such as, for example and without limitation, slip agents, anti-block agents, release agents, anti-oxidants, and plasticizers, to control e.g. processing of the polymeric material as well as to stabilize and/or otherwise control the properties of the finished processed product, also to control hardness, bending resistance, and the like.

Common industry methods of forming such polymeric compounds are satisfactory for making the various elements of painting system 1. Exemplary, but not limiting, of such processes are the commonly-known injection molding process, and other known polymer melt-fabrication processes, optionally foamed plastic-forming processes.

Painting system 1 is preferably manufactured as four different components. The four components are, body 15, including handle 23; colorant applicator 16; painting element 37; and tray 45 including, preferably as integral elements, including any partitions 47.

Common industry methods of joining such materials, such as by using polymer adhesives, thermal bonding, mechanical fasteners, and other common industry methods, suffice to join painting elements 37 to panels 35.

In the alternative, one or more of body 15, handle 23, receiving structures 30, 31, 32, and partition 47 can be separately fabricated, and then joined to one or more respective other elements, by known fabrication procedures.

There can be mentioned, for example and without limitation, a wide variety of known joinder technologies such as chemical technologies, thermal technologies and/or mechanical technologies. Common industry methods of joining such materials, such as by using polymer adhesives, thermal bonding, and/or mechanical fasteners suffice to join one or more of body 15, handle 23, receiving structures 30, 31, 32, and partition 47 to respective other ones of body 15, handle 23, receiving structures 30, 31, 32, tray 45, and partition 47.

In the alternative, or in combination, parts of painting system 1 can be made of other materials, preferably which resist corrosion, and are relatively strong/durable. Those skilled in the art are well aware of, e.g. certain metallic materials which posses such desirable qualities, and appropriate methods of forming such materials. Appropriate metallic materials include, but are not limited to, aluminum, stainless steel, and various coated metal products. Common industry methods of forming such metallic materials include shearing, bending, riveting, welding, extruding, pressing, and others.

Those skilled in the art will now see that certain modifications can be made to the apparatus and methods herein disclosed with respect to the illustrated embodiments, without departing from the spirit of the instant invention. And while the invention has been described above with respect to the preferred embodiments, it will be understood that the invention is adapted to numerous rearrangements, modifications, and alterations, and all such arrangements, modifications, and alterations are intended to be within the scope of the appended claims.

To the extent the following claims use means plus function language, it is not meant to include there, or in the instant specification, anything not structurally equivalent to what is shown in the embodiments disclosed in the specification.

1. A colorant device, adapted and configured to apply colorant compositions to a colorant receptive surface, said colorant device comprising:
(a) a body having a top and a bottom, and at least first and second receptacle structures associated with the bottom of said body; and
(b) at least one colorant applicator adapted and configured to apply a colorant composition to such colorant receptive surface, said colorant applicator and at least one of said at least first and second receptacle structures being cooperatively adapted and configured such that said at least one colorant applicator can be removably mounted in one of said at least first and second receptacle structures.

2. A colorant device as in claim 1 wherein said first and second receptacle structures comprise sliding mounting structures adapted and configured to mount a cooperatively configured said colorant applicator in the respective said receptacle structure.

3. A colorant device as in claim 1 wherein at least first and second ones of said colorant applicators are mounted in at least first and second ones of said receptacle structures.

4. A colorant device as in claim 1 wherein said body comprises a first said receptacle structure between the top of said body and at least a portion of a second said receptacle structure.

5. A colorant device as in claim 1, said body (15) having a length (L) and a width (W), said body (15) comprising a receptacle structure element (32) between extremities of the width (W).

6. A colorant device as in claim 5 wherein said receptacle structure element (32) assists in stabilizing a colorant applicator mounted in a said receptacle structure, at other than an edge of the respective said colorant applicator.

7. A colorant device as in claim 3, each of said at least first and second colorant applicators having a colorant-applying bottom, adapted and configured to apply a colorant expression to such colorant receptive surface, the colorant expression, independent of color of colorant material being applied, of said first colorant applicator being different from the colorant expression of said second colorant applicator.

8. A colorant device as in claim 1, comprising at least first, second, and third colorant applicators mounted in said body, each of said at least first, second, and third colorant applicators having a colorant-applying bottom, adapted and configured to apply a colorant expression to such colorant receptive surface, the colorant expression of said first colorant applicator being different from the colorant expression of either of said second and third colorant applicators.

9. A colorant kit adapted and configured to apply colorant compositions to a colorant receptive surface, said colorant kit comprising:
(a) a colorant device comprising
(i) a body having a top and a bottom, and at least first and second receptacle structures associated with the bottom of said body, and
(ii) at least first and second colorant applicators adapted and configured to apply colorant composition to a colorant receptive surface, said colorant applicators being removably mountable in said at least first and second receptacle structures; and
(b) a tray having a plurality of cells, at least as great in number as the number of colorant applicators which can be removably mounted in said body, said cells being separated from each other by liquid-tight separators which effectively isolate any colorant composition, in said cells, from each other,
said colorant applicators, mounted on said colorant device, and said cells in said tray, being cooperatively arrayed with respect to each other such that said colorant device can be manipulated to bring said colorant applicators into generally concurrent communication with respective ones of the cells such that said colorant applicators communicate with respective different colorant materials in different ones of the cells such that different ones of the colorant applicators pick up different colorant materials from the cells, which colorant materials can be concurrently applied, by said colorant device, to the respective colorant receptive surface.

10. A colorant kit as in claim 9 wherein all of said at least first and second receptacle structures comprise sliding mounting structures adapted and configured to mount a cooperatively configured said colorant applicator in the respective said receptacle structure.

11. A colorant kit as in claim 9 wherein said body comprises a first said receptacle structure between the top of said body and at least a portion of a second said receptacle structure.

12. A colorant kit as in claim 9, said body (15) having a length (L) and a width (W), said body (15) comprising a receptacle structure element (32) between extremities of the width (W).

13. A colorant kit as in claim 12 wherein said receptacle structure element (32) assists in stabilizing a colorant applicator mounted in a said receptacle structure, at other than an edge of the respective said colorant applicator.

14. A colorant kit as in claim 13, each of said at least first and second colorant applicators having a colorant-applying bottom, adapted and configured to apply a colorant expression to such colorant receptive surface, the colorant expression, independent of color of material being applied, of said first colorant applicator being different from the colorant expression of said second colorant applicator.

15. A colorant kit as in claim 9, comprising at least first, second, and third colorant applicators mounted in said body, each of said at least first, second, and third colorant applicators having a colorant-applying bottom, adapted and configured to apply a colorant expression to such colorant receptive surface, the colorant expression of said first colorant applicator being different from the colorant expression of either of said second and third colorant applicators.

16. A colorant kit adapted and configured to apply colorant compositions to colorant receptive surfaces, said colorant kit comprising:
(a) a colorant device comprising a body having a top and a bottom, and at least first and second receptacle structures associated with the bottom of said body, wherein said first and second receptacle structures are adapted and configured to receive respective at least first and second colorant applicators therein in a first pre-determined pattern, and
(b) a tray, comprising a bottom, an outer perimeter wall, and at least one separator, dividing said tray into a plurality of cells, each cell being adapted and configured to receive and hold liquid colorant therein without such liquid colorant flowing to an adjacent cell, the cells in said tray being arranged and configured in a second pre-determined pattern which is consistent with said tray concurrently receiving working surfaces of said at least first and second colorant applicators in the respective cells such that each such colorant applicator is received in a separate such cell, whereby colorant in ones of the cells can be transferred onto respective ones of said colorant applicators.

17. A kit as in claim 16 wherein a first said receptacle structure (C) extends downwardly from the top of said body a first distance (D1), and wherein a second said receptacle structure extends to a bottom thereof, measured downwardly from the top of said body a second distance (D2), the magnitude of the second distance (D2) being greater than the magnitude of the first distance (D1).

18. A kit as in claim 17 wherein said first receptacle structure is located between the second receptacle structure and the top of said body.

19. A method of applying colorant to a colorant receptive surface, the method comprising:
(a) depositing colorant into a tray having a plurality of separate and distinct cells which are adapted and configured to maintain separation between colorants in the respective cells;
(b) installing a first set, comprising at least first and second colorant applicators, in a body of a colorant device which is adapted and configured to receive multiple such colorant applicators in an array of such applicators;
(c) transferring at least some of such colorant from the plurality of cells onto corresponding ones of the at least first and second colorant applicators in the first set, and
(d) transferring at least some of such colorant from the at least first and second colorant applicators onto such colorant receptive surface.

20. A method as in claim 19, further comprising
(e) removing the first set of colorant applicators from the body of the colorant device, and installing a second set of colorant applicators, the first set of colorant applicators being adapted and configured to collectively define a first visual pattern of colorant expression on the colorant receptive surface, the second set of colorant applicators being adapted and configured to collectively define a second visual pattern of colorant expression on the colorant receptive surface, the second visual pattern being different from the first visual pattern, independent of color; and
(f) transferring colorant from the plurality of cells of the tray onto corresponding ones of the second set of colorant applicators; and
(g) transferring at least some of such colorant from the second set of colorant applicators onto such colorant receptive surface, or onto a second colorant receptive surface.
